(19) United States
(12) Patent Application Publication
(10) Pub. No.: US 2025/0084777 A1
(43) Pub. Date: Mar. 13, 2025

(54) OXY-FUEL HEATING AND REDUCING CO2 EMISSIONS AT AN INDUSTRIAL FACILITY

(71) Applicant: Messer Industries USA, Inc., Bridgewater, NJ (US)

(72) Inventors: Michael D. Newman, Hillsborough, NJ (US); Christopher T. Ebeling, Far Hills, NJ (US)

(73) Assignee: Messer Industries USA, Inc., Bridgewater, NJ (US)

(21) Appl. No.: 18/462,496

(22) Filed: Sep. 7, 2023

(51) Int. Cl. F01N 3/02; F01N 3/08

(52) U.S. Cl. CPC F01N 3/0205; A22B 3/086; F01N 3/08; A22B 3/00; A22B 3/005; A61D 7/04; F01N 2260/024

(57) ABSTRACT

An apparatus for producing heat and reducing emissions with an exhaust gas mixture at an industrial facility is provided, which consists of a CO2 generation chamber (61) located on-site at the industrial facility (110), the CO2 generation chamber adapted to generate an exhaust gas mixture (57) comprising gaseous carbon dioxide; a production chamber (112) located on-site at the industrial facility, the production chamber constructed and arranged to receive therein gaseous carbon dioxide and as many a product selected to be processed with the gaseous carbon dioxide at the industrial facility; and a first pipeline (74) interconnecting the CO2 generation chamber with the production chamber for delivering at least a portion of the exhaust gas mixture comprising the gaseous carbon dioxide from the CO2 generation chamber to the production chamber without the portion being vented directly to atmosphere. A related method and exhaust gas mixture is also provided.

### BACKGROUND OF THE INVENTION

The present invention relates to the field of providing heat and reducing emissions at a production or an industrial facility such as but not limited to a food processing facility.

Carbon dioxide (CO2) is required for many industrial processes and therefore, required to be available at many different types of industrial facilities. Historically, the supply of carbon dioxide to a plant's or a facility's production system or site has been provided with onsite industrial bulk gas storage tanks. The term “onsite” and “bulk” as used herein means a large tank, container or vessel disposed or installed at a processor's facility or site, and which is filled with the respective liquid from a tanker truck delivering the liquid to the onsite tank during scheduled deliveries or as needed on an emergency basis to accommodate increased demand at the site. For the majority of applications, the bulk tank contains a liquid. The bulk tank will then deliver the liquid through a pipeline or other intermediate process whereupon the liquid phase changes to a gas to be used at the site.

Therefore, a continuous, reliable supply of carbon dioxide is essential for certain industrial processes. If the supply of carbon dioxide is interrupted or ceases altogether, the facility's production may be stopped, which results in detrimental financial impact to the company. Known site operators have their onsite bulk storage tanks currently supplied by bulk carbon dioxide tanker trucks making scheduled deliveries. Unfortunately, CO2 poses possibly the greatest risk of interruption among all the gases used in industrial processes. This is because CO2 is obtained from feed gas steams which originate at feed gas suppliers such as for example refineries, ethanol plants, etc. And, the feed gas suppliers are governed by feed gas agreements which allow for outages and/or disruptions of the feed gas stream due to plant maintenance, shutdowns, outages, idling and turnarounds, from which the CO2 is obtained. In effect, the supplier and therefore the operator of a site using industrial gas has little if any control over the delivery of a continuous supply of CO2, as compared to the delivery of oxygen which is taken from air. Thus, a reliable supply of CO2 for industrial facilities and the related processes is more vulnerable to disruptions than that of oxygen.

Additionally, more often than not the facility requires heat for onsite operations to, for example, provide steam, heated water, room heating, de-icing applications, and for further processing steps for other products, etc.

Therefore, it would be advantageous to provide additional or alternate heating availability and concurrently reduce emissions at the processing facility without sacrificing production efficiencies.

Referring to FIG. 1, a known production facility 10 includes a production system 12 or chamber or equipment for which quantities or molecules of CO2 are delivered in liquid bulk for storage in carbon dioxide tank 16 or vessel for use at the facility. A pipeline 26 has a first end 28 in fluid communication with the tank 16, and an opposed end 30 in fluid communication with the production system 12. A valve 32 is mounted at the pipeline 26 to control flow of the carbon dioxide from the tank 16 to the system 12. A vaporizer 33 is constructed and arranged at the pipeline 26 between the valve 32 and the first end 28 to provide a phase change of the liquid CO2 17 from the tank 16 to gaseous CO2 downstream of the vaporizer and to be provided to the production system 12. The production system 12 vents carbon dioxide from the system through a pipeline 34 opening to an atmospheric location remote from the system and the facility 10.

A tanker truck (not shown) delivers the liquid carbon dioxide (LCO2) 17 to the tank 16 located on the property of the facility 10. The bulk tank 16 is pressurized, thereby providing a tank head pressure in order to force the corresponding bulk liquid 17 from the tank for delivery to the system 12 in a controlled, continuous manner as the facility's operations require.

The production system 12 at the facility 10 may be used for different types of processing that require carbon dioxide. For example, but not by way of limitation, the production system 12 can be used for stunning animals, slaughtering animals, processing animal parts, skinning, de-furring, de-feathering, etc. The system 12 can also be used for fire suppression systems wherein CO2 is used to displace oxygen. The system 12 can further be used for chemical inerting processes such as for example, but not by way of limitation, a chemical process to convert sodium carbonate (Na2CO3+CO2+H2O) to sodium bicarbonate (2NaHCO3), Teflon® production which requires supercritical CO2 as a solvent for the related reaction, use of CO2 to reduce pH of wastewater prior to discarding same, and use of CO2 as a nutrient for algae-like organisms which are then processed to extract green chemicals for subsequent chemical use, which are other industries requiring large reliable amounts of carbon dioxide for processing.

The production facility 10 is also provided with a combustion system 40 for providing heat for steam and hot water systems 42 at the facility. Air is blown or delivered through a pipeline 44 into the combustion system 40. A pipeline 46 is connected to and delivers natural gas (NG) from a pipeline 48 to the combustion system 40. The pipelines 46,48 may deliver other types of fuel as well such as by way of example, but not limitation, methane, propane, oil, etc. A valve 50 is operably mounted at the pipeline 46 to control flow of the NG from the pipeline 48 to the system 40.

The combustion system 40 produces carbon dioxide and other emissions which are vented from the system through a pipeline 52 opening to and atmospheric location remote from the system and the facility 10. Heat from the combustion system 40 is removed from same via pipelines 54,56 for such pipelines to direct the heat via, for example, direct or indirect heating of the steam and hot water systems 42 located at the production facility 10.

As is apparent from the known production system 12 in FIG. 1, the system is contingent upon are liable supply of the CO2 for industrial processing. However, as discussed above, CO2 outages, disruptions, and/or any other possible force majeure circumstance can adversely impact the reliable delivery of the liquid CO2 17 to the bulk storage tank 16 for producing the CO2 gas to be used in the system 12.

Additionally, the carbon dioxide emissions in the pipeline 34 from the production system 12, and the emissions in the pipeline 52 from the combustion system 40 are wasted and add to environmental concerns and problems for the facility owner and/or operator.

Therefore, an alternative to relying upon a bulk liquid CO2 delivery from off-site is needed so that there can be generated “on-demand CO2” which would both supplement the heat required at a processing facility and reduce carbon dioxide emissions from the processing facility.

### SUMMARY OF THE INVENTION

The present inventive embodiments provide a flue gas or an exhaust gas mixture from an oxyfuel combustion process located on-site at the processor's site or facility to supply carbon dioxide (CO2). The oxy fuel combustion apparatus and related method embodiments are located on-site at the industrial facility. A supply of natural gas, propane or other fuel which is already present at the industrial site, and gaseous oxygen from a bulk liquid tank, more reliably available than CO2, would be delivered to an oxyfuel burner of the combustion process. Reference here into natural gas also includes propane, and reference herein to a fuel includes any combustible fuel substance or constituent. Regarding a fuel such as natural gas for example, combustion of the gaseous oxygen and natural gas at the oxyfuel burner will result in a flue gas consisting primarily of CO2, water (H2O), some inerts (nitrogen (N2) and oxygen (O2)), and nitrous oxide (NOx). The oxygen and natural gas (or propane) are more readily and reliably available and would significantly reduce the risk of supply disruptions because the CO2 is created on site and on demand.

Therefore, an apparatus embodiment for producing heat and reducing emissions with an exhaust gas mixture at an industrial facility is provided which includes a CO2 generation chamber located on-site at the industrial facility, the CO2 generation chamber adapted to generate an exhaust gas mixture comprising gaseous carbon dioxide; a production chamber located on-site at the industrial facility, the production chamber constructed and arranged to receive therein gaseous carbon dioxide and as many a product selected to be processed with the gaseous carbon dioxide at the industrial facility; and a first pipeline interconnecting the CO2 generation chamber with the production chamber for delivering at least a portion of the exhaust gas mixture comprising the gaseous carbon dioxide from the CO2 generation chamber to the production chamber without the portion being vented directly to atmosphere.

A method embodiment for producing heat and reducing emissions with an exhaust gas mixture at an industrial facility is provided which includes generating an exhaust gas mixture comprising gaseous carbon dioxide from a CO2 generation chamber located on-site at the industrial facility; providing the exhaust gas mixture comprising the gaseous carbon dioxide to a production chamber constructed and arranged on-site at the industrial facility for receiving there in the gaseous carbon dioxide and as many a product selected to be processed with the carbon dioxide at the industrial facility; and delivering the exhaust gas mixture from the CO2 generation chamber to the production chamber, wherein at least a portion of the exhaust gas mixture from the CO2 generation chamber is not vented directly to atmosphere.

An exhaust gas mixture or composition for producing heat and reducing emissions at an industrial facility is provided consisting of a mixture of gases combusted on-site at the industrial facility for producing an exhaust gas mixture comprising carbon dioxide for use with products that require the carbon dioxide for processing at the industrial facility without direct venting of at least a portion of the exhaust gas mixture to atmosphere.

### BRIEF DESCRIPTION OF THE DRAWINGS

For a more complete understanding of the present invention, reference may be had to the detailed description of the inventive embodiments taken in conjunction with the following drawings, of which:

FIG. 1 shows a known industrial facility with a system for using a bulk supply of gaseous CO2.

FIG. 2 shows a system and related method according to the inventive embodiments of the present invention for use at an industrial facility.

### DETAILED DESCRIPTION OF THE INVENTION

Before explaining the inventive embodiments in detail, it is to be understood that the invention is not limited in its application to the details of construction and arrangement of parts illustrated in the accompanying drawings, if any, since the invention is capable of other embodiments and being practiced or carried out in various ways. Also, it is to be understood that the phraseology or terminology employed herein is for the purpose of description and not of limitation.

In the following description, terms such as a horizontal, upright, vertical, above, below, beneath and the like, are to be used solely for the purpose of clarity illustrating the invention and should not be taken as words of limitation. The drawings are for the purpose of illustrating the inventive embodiments and are not intended to be to scale.

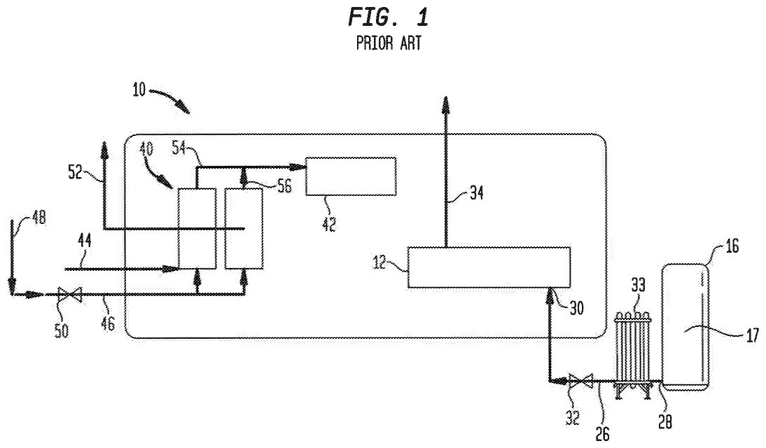

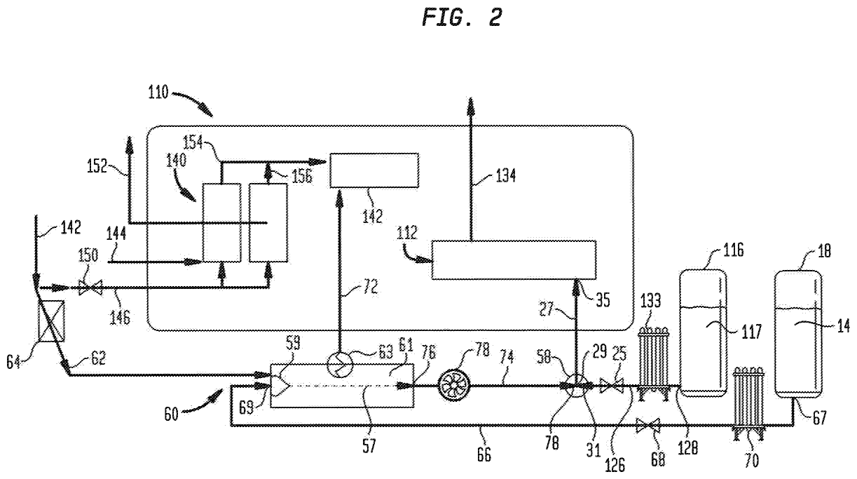

For ease of reference, elements illustrated in FIG. 2 which correspond to the elements described above with respect to FIG. 1 have been designated by corresponding reference numerals increased by one hundred. The elements of the embodiments of FIG. 2 are designated for use in the same manner as the embodiment of FIG. 1, unless otherwise stated.

Referring to FIG. 2, an industrial facility 110 includes a production system 112 or production chamber or production equipment for which quantities or molecules of carbon dioxide (CO2) are delivered in liquid bulk for storage in a carbon dioxide tank 116 or vessel for use at the facility 110. A pipeline 126 has a first end 128 in fluid communication with the tank 116, and an opposed end 31 in fluid communication with a three-way valve 58. Another pipeline 27 has an end 29 in fluid communications with the valve 58 and an opposed end 35 in fluid communication with the production system 112. A vaporizer 133 is operably mounted at the pipeline 126 to phase change the liquid CO2 117 from the tank 116 to a gaseous CO2 to be introduced into and controlled by the valve 58 to be delivered along the pipeline 27 through the end 35 into the production system 112. Another valve 25 is operably mounted to the pipeline 126 between the vaporizer 133 and the multi-port valve 58 to control the flow of the gaseous CO2 from the vaporizer into the production system 112, when the valve 58 is actuated open for such flow. The production system 112 produces carbon dioxide emissions which are vented from the system through a pipeline 134 opening to an atmospheric location remote from the system 112 and the facility 110. A bulk liquid oxygen tank 18 containing liquid oxygen 14 (LOx) therein is also positioned at the industrial facility 110. A pipeline 66 has one end 67 in fluid communication with the tank 18, and an opposed end 69 for a purpose to be described hereinafter. Downstream of the tank 18 is provided a valve 68 in the pipeline 66, and a vaporizer 70 is disposed for use with the pipeline 66 between the end 67 and the valve 68. The vaporizer 70 phase changes the liquid oxygen 14 from the tank 18 into gaseous oxygen for a purpose to be described hereinafter.

A tanker truck (not shown) for each of the liquid oxygen (LOX) 14 in the tank 18, and the liquid carbon dioxide (LCO2) 117 in the tank 116 delivers each respective liquid product to a corresponding one of the bulk tanks 18,116 located on the property of the industrial facility 110. The bulk tanks 18,116 are each pressurized, thereby providing a tank head pressure in each tank in order to force the corresponding bulk liquid from the tanks 18,116 for delivery as required in a controlled, continuous manner as the facility's operations require.

The production system 112 at the production facility 110 may be used for different types of industrial processes that require carbon dioxide, which can include but is not limited to, food animal processing, and chemical inerting processes. The system 112 can also be used for a fire suppression system wherein CO2 is used to displace oxygen. Further, the production system 112 can be used in and/or for stunning animals, sulfuric acid, chemical process to convert sodium carbonate (Na2CO3+CO2+H2O) to sodium bicarbonate (2NaHCO3), Teflon® production which requires supercritical CO2 as a solvent for the related reaction, using CO2 to reduce pH of wastewater prior to discarding same, and using CO2 as a nutrient for algae-like organisms which are then processed to extract green chemicals for subsequent chemical use, all of which are industries requiring large reliable amounts of carbon dioxide for processing.

The production facility 110 is also provided with a combustion system 140 for providing heat for steam and hot water in a heating system 142 at the facility. A pipeline 144 or blower delivers air to the combustion system 140. A pipeline 146 delivers fuel, such as for example natural gas (NG) or propane, to the combustion system 140. A valve 150 is operably mounted at the pipeline 146 to control flow of the NG fuel from another pipeline 148 which is in fluid connection with the pipeline 146 to deliver the fuel to the system 140.

The combustion system 140 produces carbon dioxide and other emissions which are vented from the system through a pipeline 152 opening to an atmospheric location remote from the system and the facility 110. Heat from the combustion system 140 is removed from same via pipelines 154,156 for such pipelines to direct the heat via, for example, direct or indirect heating of the steam and hot water for the heating system 142 located at the production facility 110.

As is apparent from the production system 112 in FIG. 2, the system is contingent upon a reliable supply of CO2. However, as discussed above, CO2 outages, disruptions, and/or any other possible force majeure circumstance can adversely impact the reliable delivery of the liquid CO2 to the bulk storage tank 116 for producing the CO2 gas to be used in the production system 112.

Additionally, the carbon dioxide emissions in the pipeline 134 from the production system 112, and the carbon dioxide emissions in the pipeline 152 from the combustion system 140 are wasted and add to environmental concerns and problems for the facility owner and/or operator.

Still referring generally to FIG. 2, the production facility 110 as mentioned above can be constructed for, among other processing applications, stunning poultry or chemical inerting processes, both of which require quantities of CO2. The facility 110 may function as follows for use, for example, as a poultry processing plant. In the facility 110, the poultry may be chickens, turkeys or other fowl by way of example only. Other types of animals can be stunned or processed as well such as, for example, pigs to produce pork products.

In general, a CO2 generation system 60 (or “CO2 system”) embodiment is located on site at the production facility 110. The CO2 generation system 60 includes a CO2 generation chamber 61 or CO2 chamber. A pipeline 62 branches off either of the pipelines 146,148 to deliver the fuel, such as NG, from the pipeline 148, to the CO2 chamber 61. A valve 64 is operably mounted to the pipeline 62 to control the flow of the NG to the CO2 chamber 61. Therefore, controlled co-action of the valves 64,150 will permit different amounts or proportions of the fuel from flowing to the combustion system 140 and the CO2 generation system 60.

The pipeline 66 has the end 67 in fluid communication with the oxygen (O2) tank 18, and the opposed end 69 is in fluid communication with the CO2 chamber 61 of the CO2 system 60. The valve 68 is operably mounted to the pipeline 66 to control the flow of gaseous oxygen from the vaporizer 70 to the CO2 chamber 61. As mentioned above, the vaporizer 70 is mounted at the pipeline 66 between the end 67 of the pipeline 66 and the valve 68, as gaseous oxygen is required for the CO2 generation system 60. The gaseous oxygen may be provided as oxygen enrichment to the CO2 system 60 to enhance combustion therein if and as necessary.

The natural gas (NG) or propane fuel will be fed into an oxyfuel burner 59 (“burner”) mounted for use at the CO2 chamber 61. Any oxygen enrichment for combustion in the CO2 chamber 61 described above may be in the range from 20.9% to 100% oxygen enrichment. The NG, or propane if used, is already available on-site at the facility 110, as the facility uses the NG (or propane) fuel for other on site operations including providing heat for the facility for boilers and hot water systems at the production facility 110. The burner 59, or for some applications a plurality of the burners, fires into the CO2 chamber 61 for producing exhaust gas and heat. The gaseous oxygen enrichment may be provided to the burner 59 as shown in FIG. 2. Alternatively, the CO2 chamber 61 could be a boiler, hot water heater or any other device or equipment which employs combustion to generate heat at the facility 110. During the combustion process, carbon dioxide (CO2) is produced, in addition to heat, water and water vapor. This mixture is the flue gas 57 (or the exhaust gas) from the CO2 chamber 61 and can be used by both the production system 112 and the heating system 142, as follows. The heat is captured via a heat exchanger 63 (or a boiler or a hot water heater or other device for capturing heat from the combustion process) at or within the CO2 system 60 and provided through a pipeline 72 interconnecting the heat exchanger and the heating system 142. The exhaust gas 57 is used for the production system 112, while the heat is captured via the heat exchanger 63 at the CO2 generation system 60 for delivery to the heating system 142. The heat exchanger 63 may be an indirect heat exchanger if steam is provided to the system 142; but can be either a direct or an indirect heat exchanger if hot water is provided to the system 142.

The exhaust gas 57 is removed from the CO2 chamber 61 through a pipeline 74 which has one end 76 for receiving the exhaust gas from the CO2 system 60, and another end 78 in fluid communication with the three-way or multi-port valve 58. Valves 64,68 also operably control the flow of the exhaust from the CO2 system 60. The three-way valve 58 is mounted for fluid communication with the end 78 of the pipeline 74, the end 31 of the pipeline 126, and the end 29 of the pipeline 27. Therefore, as shown in FIG. 2, the exhaust gas 57 containing CO2 and other combustion constituents from the CO2 chamber 61 is not immediately and automatically vented to atmosphere as occurs with known systems but rather, the exhaust gas can be provided via the valve 58 to the pipeline 27 for delivery to the production system 112. Alternatively, if for example the CO2 system 60 has to be shutdown for maintenance and/or repair, the valve 58 can be actuated to close off the pipeline 74 and receive only the gaseous CO2 in the pipeline 126 from the vaporizer 133 and thereafter, deliver the gaseous CO2 in the pipeline 27 to the production system 112 where the gaseous CO2 is needed. The CO2 tank 116 therefore functions as a back-up supply of CO2, so that only CO2 in the exhaust gas 57 from the CO2 chamber 61 is initially necessary for use in the production system 112. The three-way valve 58 controls the disposition of gaseous CO2 flow from either the CO2 chamber 61 or the CO2 tank 116. As can be seen in FIG. 2, among other aspects, the production system 112 has a source of gaseous CO2 from either the chamber 61 or the tank 116. The three-way valve 58 provides for either the flue gas exhaust 57 or the gaseous CO2 from the vaporizer 133 being separately delivered to the production system 112.

The pipeline 72 removes heat from the CO2 chamber 61, such that the heat can be used at the steam and hot water system 142. The pipeline 72 can include therein steam, hot water or some other heat exchange fluid.

For example, the steam boiler 63 can be included with the CO2 system 60 to remove heat from the exhaust gas 57 delivered through in the pipeline 72. The steam boiler receives the exhaust gas and can include the heat exchanger 63 through which water flows to be heated by the exhaust gas. The water in the heat exchanger 63 is heated to thereby produce condensate and steam for use elsewhere at remote locations in the processing facility 110.

Additionally, once a large portion of the heat is removed from the exhaust gas 57, the exhaust gas is moved through the opening end 76 into the pipeline 74, wherein the exhaust gas can be cooled further to condense excess water vapor from same or dried by a condenser prior to the exhaust gas being used at the production system 112. The exhaust gas 57 may also be pressurized by a compressor 78 associated with the pipeline 74 prior to entering the three-way valve 58 and the production system 112. The compressor 78 increases the delivery pressure of the exhaust gas 57 through the valve 58 and to the production system 112.

The tanks 18,116 can each be a bulk storage tank.

Advantages of the present embodiments include eliminating the inconvenience and risk of CO2 supply disruptions; providing on-demand CO2 supply at the production facility 110; the ability to create select mixtures of CO2 and 02 for end use in the production system 112; providing a heat source from the exhaust gas via the pipeline 72 for the heating system 142 at the production facility 110; and reducing emissions from the facility's existing combustion system 140.

Regarding the provision of heat and the reduction of emissions at the industrial facility 110 with the present embodiments, the amount of CO2 emitted is reduced by the percentage (%) of NG diverted from the existing heating process of the combustion system 40,140 to the CO2 generation system 60 embodiment. The CO2 generation system 60 captures a percentage or proportion, if not all, of the CO2 which would otherwise have been released to the atmosphere from the facility's combustion system 40,140 by using this CO2 for another process at the facility 110, thereby eliminating the immediate need for liquid bulk CO2 17,117 in the tanks 16,116. The heat generated by the CO2 generation system 60 is fed back into the production system 112 of the facility 110, so that although the facility uses the same amount of fuel (such as the NG) to produce the same amount of heat, a new source of the CO2 in the exhaust gas 57 is instead provided from the CO2 system 60 for the facility's CO2 required process.

Example. A customer with a plant or industrial facility 110 has a total heat requirement at the facility of 14.6 MMBtu/hr (millions of British Thermal Units per hour). In the facility's current state, i.e., prior to installation of the CO2 generation system 60 of the present embodiments, the plant will consume 15 kscfh (thousand standard cubic feet per hour) of natural gas (NG) fuel in order to produce 14.6 MMBtu/hr of heat from a combination air-NG combustion heating process. The customer has a CO2 demand of 817 lb/hr from the facility. In a future state, in order for the CO2 generation system to produce 817 lb/hr of CO2 gas, the system will require 6.85 kscfh of NG and produce 7.1 MMBtu/hr of heat in the process. This heat will be fed back into the facility 110. After the CO2 generation system 60 is installed, the facility's conventional air-NG combustion heating process will consume 8.15 kscfh of NG (15 kscfh−6.85 kscfh) and thus, CO2 emissions from the air-NG combustion heating process will be reduced by (8.15/15)×100=54%. The emissions from the production system 112, which the CO2 generation system 60 also supplies, will remain unchanged, as bulk CO2 117 is replaced with CO2 captured from the exhaust gas 57 containing CO2 therein for the production system 112 and the heating system 142.

According to a first illustrative embodiment, an apparatus for producing heat and reducing emissions with an exhaust gas mixture at an industrial facility, includes: a CO2 generation chamber located on-site at the industrial facility, the CO2 generation chamber adapted to generate an exhaust gas mixture comprising gaseous carbon dioxide; a production chamber located on-site at the industrial facility, the production chamber constructed and arranged to receive therein gaseous carbon dioxide and as many a product selected to be processed with the gaseous carbon dioxide at the industrial facility; and a first pipeline interconnecting the CO2 generation chamber with the production chamber for delivering at least a portion of the exhaust gas mixture comprising the gaseous carbon dioxide from the CO2 generation chamber to the production chamber without the portion being vented directly to atmosphere.

The first embodiment may also include wherein the first pipeline is constructed and arranged to deliver all the exhaust gas mixture comprising the gaseous carbon dioxide to the production chamber without any of the gaseous carbon dioxide being vented directly to the atmosphere.

The first embodiment may also include a second pipeline interconnecting the CO2 generation chamber with a heating system at the industrial facility for providing hot water and steam to the heating system, wherein at least a portion of the hot water and steam provided is not vented to the atmosphere.

The first embodiment may also include a second pipeline interconnecting the CO2 generation chamber with a heating system at the industrial facility for providing hot water and steam to the heating system, wherein none of the hot water and steam is vented directly to the atmosphere.

The first embodiment may also include a source of oxygen connected to the CO2 generation chamber.

The first embodiment may also include a source of carbon dioxide connected to the production chamber.

The first embodiment may also include a source of carbon dioxide connected to the production chamber, and a multi-port valve in fluid communication with and positioned to control a selected flow of each of the exhaust gas mixture and the carbon dioxide from the source of the carbon dioxide for delivery to the production chamber.

The first embodiment may also include fuel source containing fuel in fluid communication with the CO2 generation chamber.

The first embodiment may also include a fuel source containing fuel in fluid communication with the CO2 generation chamber, wherein the fuel comprises a flammable substance selected from the group consisting of natural gas, and propane.

The first embodiment may also include a fuel source containing fuel in fluid communication with the CO2 generation chamber, and an existing combustion chamber at the industrial facility, wherein the fuel from the fuel source may be directed to both the CO2 generation chamber and the existing combustion chamber at the industrial facility.

The first embodiment may also include wherein the CO2 generation chamber comprises a burner selected from the group consisting of an oxyfuel burner, and an air-oxyfuel burner.

The first embodiment may also include at least one of a boiler located at the industrial facility for being contacted by the exhaust gas mixture from the CO2 generation chamber; and a heat exchanger located at the industrial facility for receiving at least a portion of the exhaust gas s mixture, the heat exchanger constructed and arranged to produce cooled exhaust gas mixture comprising carbon dioxide for delivery to the production chamber.

The first embodiment may also include, wherein the product selected is from the group consisting of animals, chemical inerting processes, and a fire suppression system.

According to a second illustrative embodiment, a method for producing heat and reducing emissions with an exhaust gas mixture at an industrial facility, includes: generating an exhaust gas mixture comprising gaseous carbon dioxide from a CO2 generation chamber located on-site at the industrial facility; providing the exhaust gas mixture comprising the gaseous carbon dioxide to a production chamber constructed and arranged on-site at the industrial facility for receiving there in the gaseous carbon dioxide and as many a product selected to be processed with the carbon dioxide at the industrial facility; and delivering the exhaust gas mixture from the CO2 generation chamber to the production chamber, wherein at least a portion of the exhaust gas mixture from the CO2 generation chamber is not vented directly to atmosphere.

The second embodiment may also include delivering all the exhaust gas mixture to the production chamber without any of the exhaust gas mixture being vented directly to the atmosphere.

The second embodiment may also include providing heat from the CO2 generation chamber for heating a heating system at the industrial facility, wherein at least a portion of the heat from the CO2 generation chamber is not vented directly to the atmosphere.

The second embodiment may also include providing heat from the CO2 generation chamber for heating a heating system at the industrial facility, wherein none of the heat from the CO2 generation chamber is vented directly to the atmosphere.

The second embodiment may also include providing oxygen to the CO2 generation chamber.

The second embodiment may also include providing carbon dioxide to the production chamber.

The second embodiment may also include providing fuel to the CO2 generation chamber.

The second embodiment may also include providing fuel to the CO2 generation chamber, wherein the fuel is a flammable substance selected from the group consisting of natural gas, and propane.

The second embodiment may also include providing air and a fuel to an existing combustion chamber at the industrial facility for heating the heating system.

The second embodiment may also include providing air and a fuel to an existing combustion chamber at the industrial facility for heating the heating system, and providing the fuel to both the CO2 generation chamber and the existing combustion chamber at the industrial facility.

The second embodiment may also include cooling the exhaust gas mixture before delivering the exhaust gas mixture to the production chamber.

The second embodiment may also include, wherein a percentage of the carbon dioxide in the exhaust gas mixture is in a range of from 11% to 99%.

The second embodiment may also include, wherein the product is selected from the group consisting of animals, products requiring chemical inerting processes, and a fire suppression system.

According to a third illustrative embodiment, an exhaust gas mixture for producing heat and reducing emissions at an industrial facility, includes a mixture of gases combusted on-site at the industrial facility for producing an exhaust gas mixture comprising carbon dioxide for use with products that require the carbon dioxide for processing at the industrial facility without direct venting of at least a portion of the exhaust gas mixture to atmosphere.

It will be understood that the embodiments described herein are merely exemplary, and that one skilled in the art may make variations and modifications without departing from the spirit and scope of the invention. All such variations and modifications are intended to be included within the scope of the invention as described hereinabove and set forth in the present claims. Further, all embodiments disclosed are not necessarily in the alternative, as various embodiments may be combined to provide the desired result.

What is claimed is:

1. An apparatus (60) for producing heat and reducing emissions with an exhaust gas mixture at an industrial facility (110), comprising:
a CO2 generation chamber (61) located on-site at the industrial facility (110), the CO2 generation chamber adapted to generate an exhaust gas mixture (57) comprising gaseous carbon dioxide;
a production chamber (112) located on-site at the industrial facility, the production chamber constructed and arranged to receive therein gaseous carbon dioxide and as many a product selected to be processed with the gaseous carbon dioxide at the industrial facility; and
a first pipeline (74) interconnecting the CO2 generation chamber (61) with the production chamber (112) for delivering at least a portion of the exhaust gas mixture comprising the gaseous carbon dioxide from the CO2 generation chamber to the production chamber without the portion being vented directly to atmosphere.

2. The apparatus of claim 1, wherein the first pipeline is constructed and arranged to deliver all the exhaust gas mixture comprising the gaseous carbon dioxide to the production chamber without any of the gaseous carbon dioxide being vented directly to the atmosphere.

3. The apparatus of claim 1, further comprising a second pipeline (72) interconnecting the CO2 generation chamber (61) with a heating system (142) at the industrial facility (110) for providing hot water and steam to the heating system, wherein at least a portion of the hot water and steam provided is not vented to the atmosphere.

4. The apparatus of claim 1, further comprising a second pipeline (72) interconnecting the CO2 generation chamber (61) with a heating system (142) at the industrial facility (110) for providing hot water and steam to the heating system, wherein none of the hot water and steam is vented directly to the atmosphere.

5. The apparatus of claim 1, further comprising a source (18) of oxygen (14) connected to the CO2 generation chamber (61).

6. The apparatus of claim 1, further comprising a source (116) of carbon dioxide (117) connected to the production chamber (112).

7. The apparatus of claim 6, further comprising a multi-port valve in fluid communication with and positioned to control a selected flow of each of the exhaust gas mixture (57) and the carbon dioxide (117) from the source (116) of the carbon dioxide for delivery to the production chamber (112).

8. The apparatus of claim 1, further comprising a fuel source (148) containing fuel in fluid communication with the CO2 generation chamber (61).

9. The apparatus of claim 8, wherein the fuel comprises a flammable substance selected from the group consisting of natural gas, and propane.

10. The apparatus of claim 8, further comprising an existing combustion chamber (140) at the industrial facility (110), wherein the fuel from the fuel source may be directed to both the CO2 generation chamber (61) and the existing combustion chamber (140) at the industrial facility (110).

11. The apparatus of claim 1, wherein the CO2 generation chamber (61) comprises a burner selected from the group consisting of an oxyfuel burner, and an air-oxyfuel burner.

12. The apparatus of claim 1, further comprising at least one of a boiler (63) located at the industrial facility (110) for being contacted by the exhaust gas mixture (57) from the CO2 generation chamber (61); and a heat exchanger (63) located at the industrial facility (110) for receiving at least a portion of the exhaust gas mixture (57), the heat exchanger constructed and arranged to produce cooled exhaust gas mixture comprising carbon dioxide for delivery to the production chamber (112).

13. The apparatus of claim 1, wherein the product selected is from the group consisting of animals, chemical inerting processes, and a fire suppression system.

14. A method for producing heat and reducing emissions with an exhaust gas mixture at an industrial facility, comprising:
generating an exhaust gas mixture comprising gaseous carbon dioxide from a CO2 generation chamber located on-site at the industrial facility;
providing the exhaust gas mixture comprising the gaseous carbon dioxide to a production chamber constructed and arranged on-site at the industrial facility for receiving therein the gaseous carbon dioxide and as many a product selected to be processed with the carbon dioxide at the industrial facility; and
delivering the exhaust gas mixture from the CO2 generation chamber to the production chamber, wherein at least a portion of the exhaust gas mixture from the CO2 generation chamber is not vented directly to atmosphere.

15. The method of claim 14, further comprising delivering all the exhaust gas mixturetotheproductionchamberwithoutanyoftheexhaustgasmixturebeing vented directly to the atmosphere.

16. The method of claim 14, further comprising providing heat from the CO2 generation chamber for heating a heating system at the industrial facility, wherein at least a portion of the heat from the CO2 generation chamber is not vented directly to the atmosphere.

17. The method of claim 14, further comprising providing heat from the CO2 generation chamber for heating a heating system at the industrial facility, wherein none of the heat from the CO2 generation chamber is vented directly to the atmosphere.

18. The method of claim 14, further comprising providing oxygen to the CO2 generation chamber.

19. The method of claim 14, further comprising providing carbon dioxide to the production chamber.

20. The method of claim 14, further comprising providing fuel to the CO2 generation chamber.

21. The method of claim 20, wherein the fuel is a flammable substance selected from the group consisting of natural gas, and propane.

22. The method of claim 14, further comprising providing air (144) and a fuel (148, 146) to an existing combustion chamber (140) at the industrial facility (110) for heating the heating system (142).

23. The method of claim 22, further comprising providing the fuel to both the CO2 generation chamber (61) and the existing combustion chamber (140) at the industrial facility.

24. The method of claim 14, further comprising cooling the exhaust gas mixture before delivering the exhaust gas mixture to the production chamber.

25. The method of claim 14, wherein a percentage of the carbon dioxide in the exhaust gas mixture is in a range of from 11% to 99%.

26. The method of claim 14, wherein the product is selected from the group consisting of animals, products requiring chemical inerting processes, and a fire suppression system.

27. An exhaust gas mixture for producing heat and reducing emissions at an industrial facility, comprising a mixture of gases combusted on-site at the industrial facility for producing an exhaust gas mixture comprising carbon dioxide for use with products that require the carbon dioxide for processing at the industrial facility without direct venting of at least a portion of the exhaust gas mixture to atmosphere.
